(19) United States
(12) Patent Application Publication
(10) Pub. No.: US 2015/0260989 A1
(43) Pub. Date: Sep. 17, 2015

(54) SOCIAL DATA-AWARE WEARABLE DISPLAY SYSTEM

(71) Applicants: Hosain Sadequr Rahman, San Francisco, CA (US); Hari N. Chakravarthula, San Jose, CA (US)

(72) Inventors: Hosain Sadequr Rahman, San Francisco, CA (US); Hari N. Chakravarthula, San Jose, CA (US)

(73) Assignee: AliphCom, San Francisco, CA (US)

(21) Appl. No.: 14/205,138

(22) Filed: Mar. 11, 2014

(51) Int. Cl. G02B 27/01; H04N 5/232; G06F 17/30; H04N 13/02; H04L 29/08; G06K 9/00

(52) U.S. Cl. CPC G02B 27/017; H04L 67/10; G06K 9/00281; G06F 17/3089; H04N 13/0207; H04N 5/23219; G02B 2027/0178; G02B 2027/014; G02B 2027/0138; H04N 2013/0096

(57) ABSTRACT

Techniques associated with a social data-aware wearable display system are described, including a wearable device having a frame configured to be worn, a display coupled to the frame, the display located within a field of vision, a sensor configured to capture sensor data, and a communication facility configured to send the sensor data to another device and to receive social data to be presented on the display, the system also having an application configured to process the sensor data and to generate the social data using the sensor data.

### CROSS-REFERENCE TO RELATED APPLICATIONS

This application claims the benefit of U.S. Provisional Patent Application No. 61/780,892 (Attorney Docket No. ALI-159P), filed Mar. 13, 2013, which is incorporated by reference herein in its entirety for all purposes.

### FIELD

The present invention relates generally to electrical and electronic hardware, electromechanical and computing devices. More specifically, techniques related to a social data-aware wearable display system are described.

### BACKGROUND

Conventional techniques for accessing social data are limited in a number of ways. Conventional techniques for accessing social data, including information about persons and entities in a user's social network, typically use applications on devices that are stationary (i.e., desktop computer) or mobile (i.e., laptop or mobile computing device). Such conventional techniques typically are not well-suited for hands-free access to social data, as they typically require one or more of typing, holding a device, pushing buttons, or otherwise navigating a touchscreen, keyboard or keypad.

Conventional wearable devices also often are not hands-free, and even wearable display devices that are hands-free typically are not equipped to access social data automatically, and particularly in context (i.e., pertaining to a user's behavior, location and environment).

Thus, what is needed is a solution for a social data-aware wearable display system without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary social data-aware wearable display system;

FIG. 2 illustrates an exemplary wearable display device; and

FIG. 3 illustrates another exemplary wearable display device.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a device, and a method associated with a wearable device structure with enhanced detection by motion sensor. In some embodiments, motion may be detected using an accelerometer that responds to an applied force and produces an output signal representative of the acceleration (and hence in some cases a velocity or displacement) produced by the force. Embodiments may be used to couple or secure a wearable device onto a body part. Techniques described are directed to systems, apparatuses, devices, and methods for using accelerometers, or other devices capable of detecting motion, to detect the motion of an element or part of an overall system. In some examples, the described techniques may be used to accurately and reliably detect the motion of a part of the human body or an element of another complex system. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

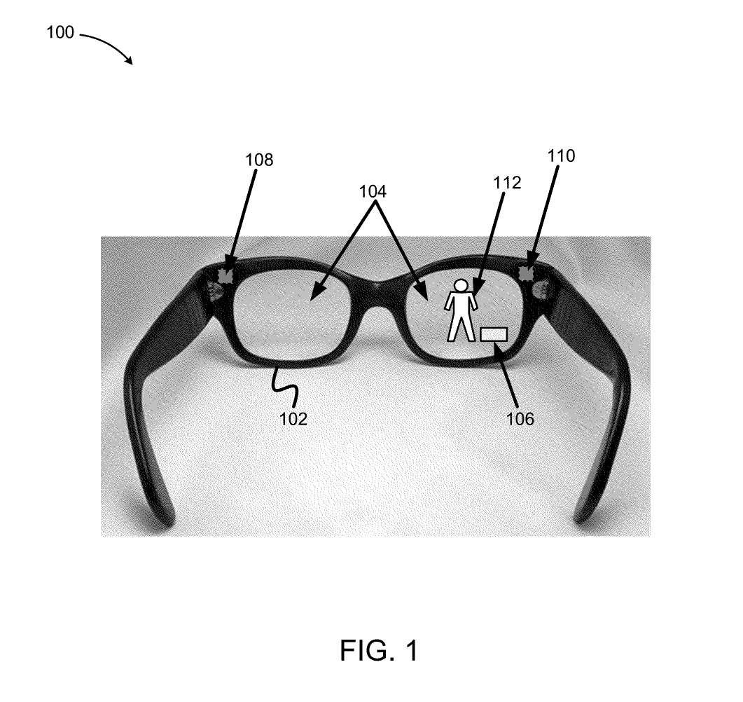

FIG. 1 illustrates an exemplary wearable display device. Here, wearable device 100 includes frame 102, lenses 104, display 106, and sensors 108-110. In some examples, an object may be seen through lenses 104 (e.g., person 112). In some examples, frame 102 may be implemented similarly to a pair of glasses. For example, frame 102 may be configured to house lenses 104, which may be non-prescription or prescription lenses. In some examples, frame 102 may be configured to be worn on a face (e.g., over a bridge of a nose, over a pair of ears, or the like) such that a user may be able to see through lenses 104. In some examples, frame 102 may include sensors 108-110. In some examples, one or more of sensors 108-110 may be configured to capture visual (e.g., image, video, or the like) data. For example, one or more of sensors 108-110 may include a camera, light sensor, or the like, without limitation. In other examples, one or more of sensors 108-110 also may be configured to capture audio data or other sensor data (e.g., temperature, location, light, or the like). For example, one or more of sensors 108-110 may include a microphone, vibration sensor, or the like, without limitation. In some examples, one or more of sensors 108-110, or sensors disposed elsewhere on frame 102 (not shown), may be configured to capture secondary sensor data (e.g., environmental, location, movement, or the like). In some examples, one or more of sensors 108-110 may be disposed in different locations on frame 102 than shown, or coupled to a different part of frame 102, for capturing sensor data associated with a different direction or location relative to frame 102.

In some examples, display 106 may be disposed anywhere in a field of vision or field of view of an eye. In some examples, display 106 may be disposed on one or both of lenses 104. In other examples, display 106 may be implemented independently of lenses 104. In some examples, display 106 may be disposed in an unobtrusive portion of said field of vision. For example, display 106 may be disposed on a peripheral portion of lenses 104, such as near a corner of one or both of lenses 104. In other examples, display 106 may be implemented unobtrusively, for example by operating in two or more modes, where display 106 is disabled in one mode and enabled in another mode. In some examples, in a disabled mode, or even in a display-enabled mode when there is no data to display (i.e., a non-display mode), display 106 may be configured to act similar to or provide a same function as lenses 104 (i.e., prescription lens or non-prescription lens). For example, in a non-display mode, display 106 may mimic a portion of a clear lens where lenses 104 are clear. In another example, in a non-display mode, display 106 may mimic a portion of a prescription lens having a prescription similar, or identical, to lenses 104. In still another example, in either a display or non-display mode, display 106 may have other characteristics in common with lenses 104 (e.g., UV protection, tinting, coloring, and the like). In some examples, when there is social data (i.e., generated and received from another device, as described herein) to present in display 106, information may appear temporarily, and then disappear after a predetermined period of time (i.e., for a length of time long enough to be read or recognized by a user). In some examples, display 106 may be implemented using transmissive display technology (e.g., liquid crystal display (LCD) type, or the like). In other examples, display 106 may be implemented using reflective display technology (e.g., liquid crystal on silicon (LCoS) type, or the like), for example, with an electrically controlled reflective material in a backplane. In other examples, the quantity, type, function, structure, and configuration of the elements shown may be varied and are not limited to the examples provided.

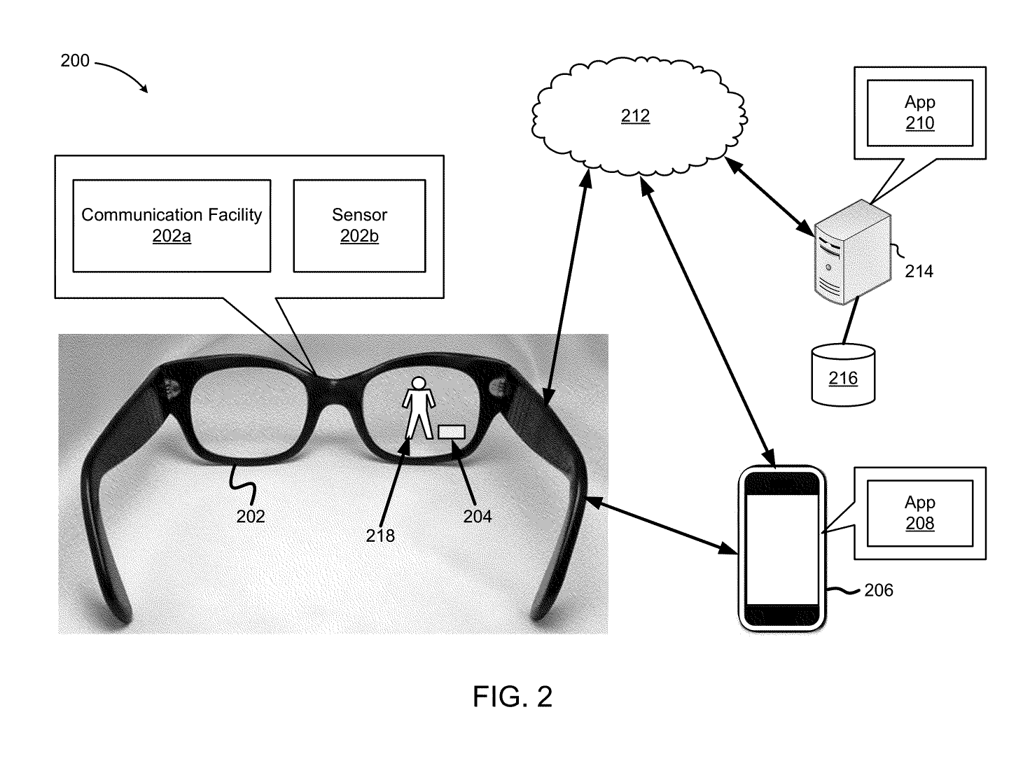

FIG. 2 illustrates an exemplary social data-aware wearable display system. Here, system 200 includes wearable device 202, including display 204, mobile device 206, applications 208-210, network 212, server 214 and storage 216. Like-numbered and named elements may describe the same or substantially similar elements as those shown in other descriptions. In some examples, wearable device may include communication facility 202a and sensor 202b. In some examples, sensor 202b may be implemented as one or more sensors configured to capture sensor data, as described herein. In some examples, communication facility 202a may be configured to exchange data with mobile device 206 and network 212 (i.e., server 214 using network 212), for example using a short-range communication protocol (e.g., Bluetooth®, NFC, ultra wideband, or the like) or longer-range communication protocol (e.g., satellite, mobile broadband, GPS, WiFi, and the like). As used herein, “facility” refers to any, some, or all of the features and structures that are used to implement a given set of functions. In some examples, mobile device 206 may be implemented as a mobile communication device, mobile computing device, tablet computer, or the like, without limitation. In some examples, wearable device 202 may be configured to capture sensor data (i.e., using sensor 202b) associated with an object (e.g., person 218) seen by a user while wearing wearable device 202. For example, wearable device 202 may capture visual data associated with person 218 when a user wearing wearable device 202 sees person 218. In some examples, wearable device 202 may be configured to send said visual data to mobile device 206 or server 214 for processing by application 208 and/or application 210, as described herein. In some examples, mobile device 206 also may be implemented with a secondary sensor (not shown) configured to capture secondary sensor data (e.g., movement, location (i.e., using GPS), or the like).

In some examples, mobile device 206 may be configured to run or implement application 208, or other various applications. In some examples, server 214 may be configured to run or implement application 210, or other various applications. In other examples, applications 208-210 may be implemented in a distributed manner using both mobile device 206 and server 214. In some examples, one or both of applications 208-210 may be configured to process sensor data received from wearable device 202, and to generate pertinent social data (i.e., social data relevant to sensor data captured by wearable device 202, and thus relevant to a user's environment) using the sensor data for presentation on display 204. As used herein, “social data” may refer to data associated with a social network or social graph, for example, associated with a user. In some examples, social data may be associated with a social network account (e.g., Facebook®, Twitter®, LinkedIn® , Instagram®, Google+®, or the like). In some examples, social data also may be associated with other databases configured to store social data (e.g., contacts lists and information, calendar data associated with a user's contacts, or the like). In some examples, application 208 may be configured to derive characteristic data from sensor data captured using wearable device 202. For example, wearable device 202 may be configured to capture visual data associated with one or more objects (e.g., person 218, or the like) able to be seen or viewed using wearable device 202, and application 208 may be configured to derive a face outline, facial features, a gait, or other characteristics, associated with said one or more objects. In some examples, application 210 may be configured to run various algorithms using sensor data, including secondary sensor data, captured by wearable device 202 in order to generate (i.e., gather, obtain or determine by querying and cross-referencing with a database) pertinent social data associated with said sensor data. In some examples, application 210 also may be configured to run one or more algorithms on secondary sensor data and derived data from mobile device 206 in order to generate pertinent social data associated with said sensor data. In some examples, said algorithms may include a facial recognition algorithm, a social database mining algorithm, an intelligent contextual information provisioning algorithm (i.e., to enable mobile device 206 and/or wearable device 202 to provide data or services in response, or otherwise react, to sensor, social, and environmental data), or the like. In some examples, one or both of applications 208-210 also may be configured to format or otherwise process data (i.e., pertinent social data) to be presented, for example, using display 204.

In some examples, pertinent social data may be gathered from social networking databases, or other databases configured to store social data, as described herein. In some examples, pertinent social data may include identity data associated with an identity, for example, of a member of a social network. In some examples, identity data may reference or describe a name and other identifying information (e.g., a telephone number, an e-mail address, a physical address, a relationship (i.e., with a user of the social network to which said member belongs), an unique identification (e.g., a handle, a username, a social security number, a password, or the like), and the like) associated with an identity. In some examples, applications 208-210 may be configured to obtain identity data associated with sensor data, for example, associated with an image or video of person 218, and to provide said identity data to wearable device 202 to present using display 204. In some examples, pertinent social data generated by also may reference or describe an event or other social information (e.g., a birthday, a graduation, another type of milestone, a favorite food, a frequented venue (e.g., restaurant, café, shop, store, or the like) nearby, a relationship to a user (e.g., friend of a friend, co-worker, boss's daughter, or the like), a relationship status, or the like) relevant to a member of a social network identified using sensor data. In other examples, the quantity, type, function, structure, and configuration of the elements shown may be varied and are not limited to the examples provided.

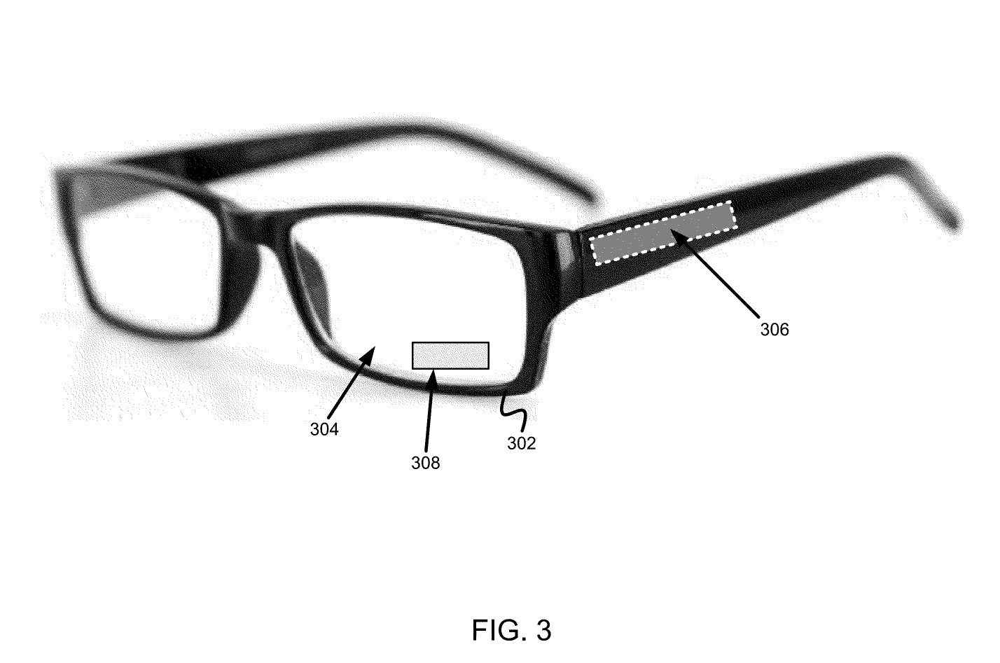

FIG. 3 illustrates another exemplary wearable display device. Here, wearable device 302 includes viewing area 304 and focus feature 306. Like-numbered and named elements may describe the same or substantially similar elements as those shown in other descriptions. In some examples, viewing area 304 may include display 308, which may be disposed on some or all of viewing area 304. In some examples, display 308 may be dynamically focused using focus feature 306, for example, implemented in a frame arm of wearable device 302, to adapt to a user's eye focal length such that information and images (i.e., graphics) presented on display 308 appear focused to a user. In some examples, focus feature 306 may be implemented with a sensor (or an array of sensors) to detect a touching motion (e.g., a tap of a finger, a sliding of a finger, or the like). In some examples, focus feature 306 may be configured to translate said touching motion into a focal change implemented on display 308, for example, using software configured to adjust display 308 or optically moving lens surface with respect to each other (i.e., laterally or vertically). In other examples, a camera (not shown), either visual or infrared or other type, may be implemented facing a user and configured to sense one or more parameters associated with a user's eye (e.g., pupil opening size, or the like). Said one or more parameters may be used by wearable device 308 to automatically focus information or images presented on display 308. In still other examples, the quantity, type, function, structure, and configuration of the elements shown may be varied and are not limited to the examples provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A system, comprising:
a wearable device comprising a frame configured to be worn, a display coupled to the frame, the display being disposed within a field of vision, a sensor configured to capture sensor data, and a communication facility configured to send the sensor data to another device and to receive social data to be presented on the display; and
an application configured to process the sensor data and to generate the social data using the sensor data.

2. The system of claim 1, wherein the sensor data comprises visual data.

3. The system of claim 1, wherein the sensor data comprises audio data.

4. The system of claim 1, wherein the sensor comprises a camera configured to capture image data.

5. The system of claim 1, wherein the sensor comprises a camera configured to capture video data.

6. The system of claim 1, wherein the display is disposed on a lens coupled to the frame.

7. The system of claim 1, further comprising another sensor configured to capture secondary sensor data, the social data being generated using the sensor data and the secondary sensor data.

8. The system of claim 1, wherein the application further is configured to generate identity data using a facial recognition algorithm.

9. The system of claim 1, wherein the application is configured to generate the social data using a social database mining algorithm.

10. The system of claim 1, wherein the application is configured to generate the social data using an intelligent contextual information provisioning algorithm.

11. The system of claim 1, wherein the application further is configured to cross-reference the sensor data with stored social data associated with a social network.

12. A system, comprising:
a wearable device comprising a frame configured to be worn, a display coupled to the frame, a sensor configured to capture sensor data, and a communication facility configured to send and receive data; and
a remote device configured to operate an application, the application configured to generate social data using the sensor data, the remote device configured to send the social data to the wearable device.

13. The system of claim 12, wherein the remote device is configured to access identity data from a social network.

14. The system of claim 12, wherein the application is configured to run a facial recognition algorithm.

15. The system of claim 12, wherein the application is configured to run a social database mining algorithm.

16. The system of claim 12, wherein the application is configured to run an intelligent contextual information provisioning algorithm.

17. The system of claim 12, wherein the display is configured to operate in at least two modes.

18. The system of claim 12, wherein the display is coupled to a lens, the display configured to operate in at least two modes comprising a non-display mode and a display mode, the display configured to provide a same function as the lens in the non-display mode and to present data the display mode.

19. The system of claim 12, wherein the other device comprises a mobile device.

20. The system of claim 12, wherein the other device comprises a network.
